(19) United States
(12) Patent Application Publication
(10) Pub. No.: US 2025/0351209 A1
(43) Pub. Date: Nov. 13, 2025

(54) TECHNIQUES TO FACILITATE MULTIPLE SESSIONS A WIRELESS DEVICE WITH A MOBILE CORE NETWORK VIA A TRUSTED WIRELESS LOCAL AREA NETWORK

(71) Applicant: Cisco Technology, Inc., San Jose, CA (US)

(72) Inventors: Srinath Gundavelli, San Jose, CA (US); Vimal Srivastava, Bangalore (IN); Ravi Kiran Guntupalli, Cumming, GA (US)

(21) Appl. No.: 18/658,067

(22) Filed: May 8, 2024

(51) Int. Cl. H04W 76/15; H04W 40/02; H04W 84/12; H04W 92/02

(52) U.S. Cl. CPC H04W 76/15; H04W 40/02; H04W 84/12; H04W 92/02

(57) ABSTRACT

Provided herein are techniques to facilitate multiple sessions for a wireless device with a mobile core network via a trusted WLAN. In one example, a method may include obtaining, by an interworking function of a WLAN, an indication that a wireless device seeks to establish a session with the mobile core network, wherein the indication comprises first parameters associated with the session. The method may further include upon identifying, by the interworking function, that the first parameters match a route selection rule of a plurality of route selection rules for the wireless device, facilitating establishment of the session with the mobile core network based on the first parameters. In one instance, the wireless device is not capable of Non-Access-Stratum (NAS) signaling with the mobile core network via the WLAN.

### TECHNICAL FIELD

The present disclosure relates to network equipment and services.

### BACKGROUND

Networking architectures have grown increasingly complex in communications environments, particularly wireless networking environments. For example, mobile communication networks have grown substantially as end users become increasingly connected to mobile network environments. In some instances, it may be desirable to facilitate Third Generation Partnership Project (3GPP) mobile core network services, such as 3GPP Fifth Generation (5G) services, for wireless devices that may connect to the 3GPP 5G mobile core network via a wireless local area network (WLAN). However, there are currently limitations regarding 5G service activation for wireless devices operating in such environments. Thus, there are significant challenges with regard to providing mobile core network services to wireless devices via a wireless local area network.

### BRIEF DESCRIPTION OF THE DRAWINGS

FIG. 1 is a block diagram of a system that can be implemented to facilitate multiple sessions for a wireless device with a mobile core network via a trusted wireless local area network (WLAN), according to an example embodiment.

FIGS. 2A, 2B, 2C, and 2D are a message sequence diagram illustrating various example operations that can be performed to facilitate multiple sessions for a wireless device with a mobile core network via a trusted wireless local area network, according to an example embodiment.

FIG. 3 is a flow chart depicting a method according to an example embodiment.

FIG. 4 is another flow chart depicting another method according to an example embodiment.

FIG. 5 illustrates a hardware block diagram of a computing device configured to perform functions associated with operations discussed in connection with embodiments herein.

### DETAILED DESCRIPTION

### Overview

Embodiments herein provide techniques to facilitate or enable multiple sessions with mobile core network service for a wireless device via a trusted wireless local area network (WLAN), such as via a trusted Institute of Electrical and Electronics Engineers (IEEE) 802.11 WLAN or Wi-Fi® network. More specifically, embodiments herein provide techniques to enable multiple protocol data unit (PDU) session support (referred to herein as a ‘multi-PDU’ capability) for a trusted WLAN (via a trusted WLAN AP (TWAP) and a trusted WLAN interworking function (TWIF) of the WLAN) in order to enable multiple PDU sessions be provided for each of one or more wireless devices that are not capable of Non-Access-Stratum (NAS) signaling with a 3GPP 5G mobile core network when connected to a trusted WLAN access. Such wireless devices that are NAS-uncapable over a WLAN access are referred to herein as Non-5G Capable over WLAN (N5CW) devices.

In at least one embodiment, a computer-implemented method is provided that may include obtaining, by an interworking function of a WLAN that interfaces with a control plane function and a user plane function of a mobile core network, an indication that a wireless device seeks to establish a session with the mobile core network, wherein the indication comprises first parameters associated with the session. The method may further include upon identifying that the first parameters match a route selection rule of a plurality of route selection rules for the wireless device, facilitating establishment of the session with the mobile core network based on the first parameters. In one instance, the wireless device is not capable of Non-Access-Stratum (NAS) signaling with the mobile core network via the WLAN.

### Example Embodiments

In a WLAN, such as via an IEEE 802.11 WLAN or Wi-Fi® network one or more wireless access points (APs), also referred to interchangeably herein as WLAN APs, can provide wireless Radio Frequency (RF) coverage over which one or more wireless devices (e.g., mobile/smart phones, Internet of Things (IoT) devices, etc.) can connect to the wireless APs in order to connect to one or more data networks (e.g., the public Internet, an enterprise network operated by an enterprise entity (e.g., a business, institution, university, etc.), and/or the like.

Embodiments herein refer to trusted WLAN environments. Generally, in a trusted WLAN, a WLAN operator and a 3GPP/5G mobile core network operator can have a business relationship or, in some instances, may be the same operator (that owns/operates both the WLAN/3GPP networks) such that there is an established trust and shared security configurations that allow the access operator(s) to secure traffic, apply Quality of Service (QOS) policies, etc. In an untrusted WLAN, the untrusted WLAN does not identify the 3GPP/5G network and does not provide any specialized services for the traffic associated to tat network operator. Thus, an untrusted WLAN may be considered an over-the-top access between a UE and a 3GPP operator's network in which such WLAN access may just be considered an internet provider.

For trusted WLANs, 3GPP standards have defined a trusted WLAN interworking model or architecture involving a WLAN access that includes a trusted WLAN AP (TWAP) and trusted WLAN interworking function (TWIF) in which the TWIF terminates the N1, N2, and N3 interfaces with a 3GPP mobile core network (i.e., N1 and N2 with an Access and Mobility Management Function (AMG) and N3 with a User Plane Function (UPF)). In such an architecture, a user equipment (UE) that cannot support Non-Access-Stratum (NAS) signaling on the WLAN access can instead rely on the TWIF to perform interworking operations/signaling with the 5G AMF for N1 NAS signaling on behalf of the UE.

The UE in this context, which is 5G capable, but is NAS-uncapable on the WLAN access, is referred to as a Non-5G Capable over WLAN (N5CW) device in that the N5CW does not support NAS signaling when connected on the WLAN access. For N5CW devices, the TWIF can implement a complete NAS protocol stack and exchange NAS messages with the AMF. The TWIF can also tunnel user plane traffic to the UPF (via the N3 interface).

However, there are currently major limitations to the 3GPP defined TWAP/TWIF interworking model for N5CW devices in that 3GPP standards-based procedures limit N5CW device connectivity to a mobile core network to a singular Protocol Data Unit (PDU) session/Data Network Name (DNN) access (i.e., current standards limit an N5CW device to one PDU session with a mobile core network when the N5CW device is connected to a trusted WLAN). Thus, a TWIF configured in accordance with current 3GPP standards can only signal default, pre-configured parameters for single PDU session activation for an N5CW device that seeks to connect to a 5G mobile core network via a trusted WLAN connection.

Thus, in the absence of any NAS signaling interface between the UE and a TWAP/TWIF, current 3GPP standards do not provide support for multiple PDU sessions to be supported for N5CW devices. Further, current 3GPP standards do not provide triggers for dynamic PDU session activation, deactivation, and/or for obtaining PDU session address configuration by an N5CW device for multiple PDU sessions. Enabling a full NAS protocol stack for such N5CW devices can be difficult, as there is currently no support for the complex 3GPP NAS protocol stack via the WLAN/Wi-Fi interface of such devices.

Embodiments herein provide a light-weight alternative to facilitate multiple PDU (multi-PDU) session activation by a TWIF, which can provide semantics that are missing in current 3GPP standards, without requiring new protocol stacks to be implemented for N5CW devices. Broadly, in accordance with embodiments herein, a UE Route Selection Policy (URSP) envelope containing multiple URSP rules can be obtained by a TWIF for an N5CW device connected to a WLAN access (TWAP/TWIF) that seeks registration with a 5G mobile core network.

In accordance with embodiments herein, the N5CW device connected to the WLAN access can potentially signal, for each of one or more PDU sessions sought by the N5CW device, various PDU session parameters (e.g., S-NSSAI, DNN, etc., as discussed via embodiments herein) over 802.11 signaling messages with a TWAP/TWIF (Association Request/Response, Probe Request/Response, and/or 802.11 Action frames) that is enhanced to provide multi-PDU support. In at least one embodiment, upon identifying, based on session/service parameters obtained from the N5CW device, a matching URSP rule of the URSP envelope obtained for the N5CW device, the TWIF can facilitate establishment of a corresponding PDU session with the 5G mobile core network using the parameters obtained from the N5CW device. Thus, in at least one embodiment, the TWIF may operate as a ‘gatekeeper’ for ensuring that any PDU sessions sought by the N5CW device are allowed to be established for the N5CW device based on identifying a corresponding URSP rule that includes parameters that match those indicated by the N5CW device. The N5CW device can request multiple sessions using multiple different parameters, which can be facilitated by the TWIF based on different URSP rules that can be included in the URSP envelope for the N5CW device. The TWIF can also utilize URSP rules for a given N5CW device in order to route data traffic for the N5CW device between the N5CW device and a corresponding PDU session established to handle the data traffic.

Further, embodiments herein may facilitate techniques through which a trusted WLAN (e.g., TWAP/TWIF) and/or an N5CW device may signal capability support indications for various signaling extensions discussed herein that can be utilized to support multi-PDU session establishment for trusted WLAN/mobile core network interworking architectures.

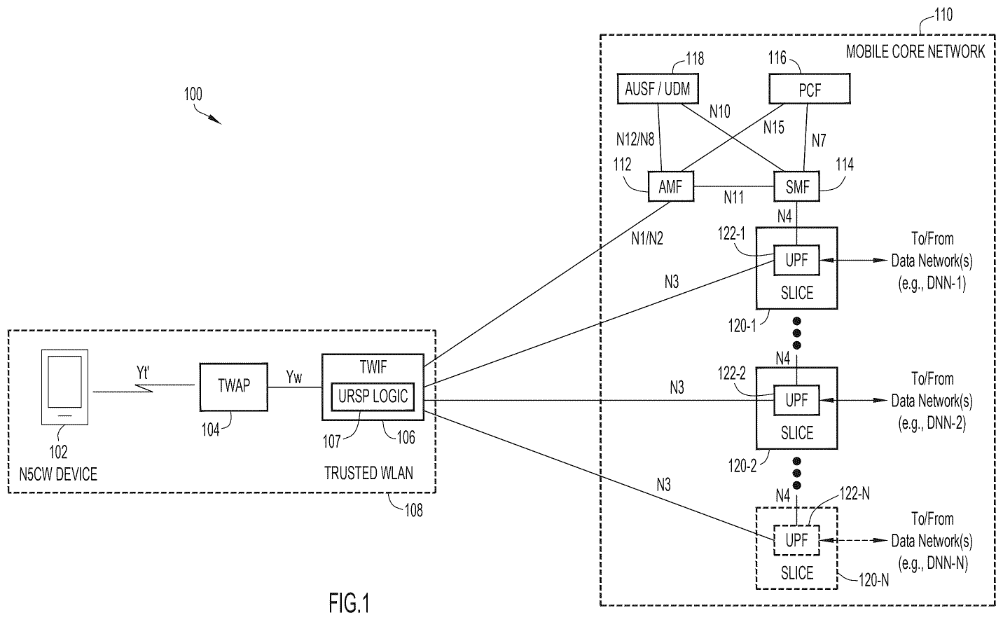

Referring to FIG. 1, FIG. 1 is a block diagram of a system 100 that may be implemented to facilitate multiple sessions for a wireless device with a mobile core network service via a trusted WLAN 108, according to an example embodiment. In at least one embodiment, system 100 may include trusted WLAN 108 and a mobile core network 110.

In at least one embodiment, trusted WLAN 108 may include a trusted WLAN AP (TWAP) 104 and trusted WLAN interworking function (TWIF) 106 in which the TWIF 106 may include user equipment (UE) route selection policy (URSP) logic 107. In various embodiments, TWAP 104 and TWIF 106 may be implemented as separate elements or may be implemented as a combined TWAP/TWIF element.

Mobile core network 110 may be implemented as any combination of a Fourth Generation/Long Term Evolution (4G/LTE) core network, a 5G core (5GC) network, a next generation (nG) core network (e.g., sixth generation (6G) or beyond), and/or the like. In at least one embodiment, mobile core network 110 may include an Access and Mobility Management Function (AMF) 112, a Session Management Function (SMF) 114, a Policy Control Function (PCF) 116, and a combined Authentication Server Function (AUSF) and Unified Data Management (UDM) entity shown in FIG. 1 as AUSF/UDM 118. In some embodiments, the UDM can interface with and/or be implemented in combination with a Unified Data Repository (UDR) (not shown in FIG. 1).

A number of network slices may also be provided via mobile core network 110, such as a network slice 120-1 including at least one User Plane Function (UPF) 122-1 in which network slice 120-1 may be associated/interface with a Data Network Name (DNN) such as a DNN-1 as shown in FIG. 1 associated with a domain ‘DNN-1.com’. Other network slices may be provided via mobile core network 110, such as a network slice 120-2 including at least one UPF 122-2 in which network slice may be associated/interface with another DNN, such as a DNN-2 associated with a domain ‘DNN-2.com’. Any number of network slices 120-N including one or more corresponding UPFs 122-N can be provided for mobile core network 110 in accordance with embodiments herein.

Generally, a network slice is a logical end-to-end network, often instantiated via a combination of slice resources, such as virtual or virtualized network functions (VNFs), in which the network slice can be dynamically created (instantiated) and may include any combination of mobile core network functions/functionality (e.g., any combination of user plane and/or control plane functions). Thus, a network slice can generally refer to a group or set of slice resources that are configured and instantiated in order to facilitate mobile network services. Various example network slice types can include, but not be limited to, a cellular vehicle to everything (V2X) network slice type that can provide cellular V2X services, a massive IoT (mIoT) network slice type that can provide IoT related services, an Ultra-Reliable Low-Latency Communication (URLLC) network slice type that can provide URLLC services, an enhanced Mobile Broadband (eMBB) network slice type that can provide mobile broadband services, a massive Machine-Type Communication (mMTC) network slice type that can provide MTC services, a High Performance Machine-Type Communication (HMTC) network slice type that can provide HMTC services, etc. Other slice types can be configured/instantiated by a mobile network operator that may or may not conform to standards-based network slice types.

Although only UPFs are shown for slices 120-1, 120-2, and 120-N, it is to be understood that any combination of NFs may be provided for network slices in accordance with embodiments herein. In accordance with 3GPP standards, a network slice may be identified via a Single Network Slice Selection Assistance Information (S-NSSAI) identifier; however, for various examples/operations discussed for embodiments herein, network slices may be identified using numerical labels, for ease of illustration/discussion only.

Various elements of system 100 may interface with each other. For example, N5CW device 102 may interface with TWAP 104 via an over-the-air (OTA) WLAN Radio Frequency (RF) connection, such via as an IEEE 802.11 (any appropriate variant) connection with TWAP 104 in which the N5CW device 102 and the TWAP 104 can communicate via any appropriate WLAN/802.11 (any appropriate variant, such as Wi-Fi 5, 6, 6E, 7, and/or any future variant) communications. The interface between N5CW device 102 and TWAP 104 is illustrated as a 3GPP Yt′ interface/reference point. Communications between N5CW device 102 and the TWAP 104 may involve various enhanced WLAN/802.11 (any variant thereof) messaging/signaling in accordance with embodiments herein. The TWAP 104 may further interface with TWIF 106 via a 3GPP Yw interface/reference point. As noted above, in various embodiments, TWAP 104 and TWIF 106 may be implemented as separate elements in which the Yw interface interconnecting the elements may be a wired interface or may be implemented as a combined element in which the Yw interface may be facilitated via internal logic provided for the combined TWAP/TWIF element.

The TWIF 106 further facilitates interfacing/communications with the mobile core network 110 via various network interfaces, specifically, interfacing with a control plane function of the mobile core network 110, such as AMF 112 via 3GPP N1 (for Non-Access-Stratum (NAS) signaling) and N2 reference points/interfaces, and with at least one user plane function of the mobile core network 110, such as UPF 122-1 of network slice 120-1 and UPF 122-2 of network slice 120-2 (as well as any other UPFs/network slices) via corresponding 3GPP N3 reference points/interfaces. Thus, TWIF 106 terminates the N1 and N2 control plane interfaces with mobile core network 110 and also N3 user plane interfaces with mobile core network 110 in accordance with embodiments herein.

Also shown in trusted WLAN 108 is a wireless device that is considered to be a Non-5G-Capable over WLAN (N5CW) device 102 in that the N5CW device 102 does not support 5GC NAS signaling on the WLAN access (via TWAP 104). In accordance with embodiments herein, N5CW device 102 relies on the TWIF 106 to perform NAS N1 interworking operations/signaling with the mobile core network 110 on behalf of the N5CW device 102.

Regarding mobile core network, AMF 112 may interface with SMF 114 via a 3GPP N11 interface, AMF 112 may interface with the AUSF via a 3GPP N12 interface and with the UDM via a 3GPP N8 interface, AMF 112 may interface with PCF via a 3GPP N15 interface, SMF 114 may interface with the UDM via an N10 interface, and SMF 114 may interface with the PCF 116 via an N7 interface. The SMF 114 may further interface with each of UPF 122-1 of slice 120-1, UPF 122-2 of slice 120-2, and any other UPF 122-N of any other slice 120-N via corresponding 3GPP N4 interfaces. Each of UPF 122-1 of slice 120-1, UPF 122-2 of slice 120-2, and any other UPF 122-N of any other slice 120-N may interface with one or more data network(s) (not shown in FIG. 1), such as the public Internet, an enterprise/private network (e.g., a business entity, a government entity, an education entity, etc. to serve enterprise purposes), an Internet Protocol (IP) Multimedia Subsystem (IMS), an Ethernet network/switching system, and/or the like, that may be referred to herein as various DNNs.

Generally, TWAP 104 may include, but not be limited to, any hardware and/or software capable of performing baseband signal processing (such as modulation/demodulation) as well as hardware (e.g., baseband processors (modems), transmitters and receivers, transceivers, and/or the like)), software, logic and/or the like to facilitate signal transmissions and signal receptions, via antenna assemblies (not shown) or the like in order to provide wireless communications that may be considered long-range wireless communications, such as, but not limited to, IEEE 802.11/Wi-Fi (including any variations thereof) wireless communications, Bluetooth® wireless communications, or the like. The TWAP 104/TWIF 106 may include any hardware and/or software capable of performing wired communications, such as Ethernet drivers, Ethernet ports, and/or any other I/O elements capable of facilitating wired communications, for example, with mobile core network/5GC elements.

A wireless device, such as N5CW device 102, a user equipment (UE), or any other wireless devices discussed herein, may be considered any electronic device, etc. that initiates a connection or communication session with a wireless network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a router or gateway with a wireless interface, a wireless enabled device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more wireless networks, such as TWAP 104. In some instances, the N5CW device 102 may be operated by/associated with a user/subscriber.

Broadly, embodiments of system 100 may facilitate mobile network service or, more specifically, multi-PDU support for a trusted WLAN/mobile core network interworking architecture, such as interworking between trusted WLAN 108 and mobile core network 110, through various aspects, such as capability indication operations, service parameter exchanges, PDU session activation/deactivation operations, and/or address configuration operations as discussed in further detail herein.

During operation in at least one embodiment, trusted WLAN 108 may facilitate an access network including TWAP 104 and TWIF 106 (including URSP logic 107) that is capable of supporting various multi-PDU operations/extensions such that TWAP 104 may (on behalf of the TWIF 106) indicate or communicate support for such multi-PDU operations/extensions toward N5CW device 102 via one or more 802.11/WLAN transmissions/messages, such as via an 802.11/WLAN beacon message, via an 802.11/WLAN probe response message, and/or via an 802.11/WLAN association response message. The various WLAN messages transmitted by TWAP 104 can be enhanced to carry a multi-PDU capability indication via a corresponding flag, bit, control word, information element (IE), vendor specific IE (VSIE), combinations thereof, and/or the like that can signal to N5CW device 102 that the trusted WLAN 108 can support multi-PDU extensions/messaging and can provide multi-PDU support for the N5CW device 102 in accordance with embodiments herein.

Further, in at least one embodiment, an N5CW device capable of supporting various multi-PDU operations/extensions in accordance with the embodiments herein, such as N5CW device 102, may indicate support for such multi-PDU operations/extensions via one or more 802.11/WLAN transmissions/messages, such as via an 802.11/WLAN probe request message and/or via an 802.11/WLAN association request message. The various WLAN messages transmitted by N5CW device 102 can be enhanced to carry a multi-PDU capability indication via a corresponding flag, bit, control word, IE, VSIE, combinations thereof, and/or the like that can signal to the TWAP 104/TWIF 106 that the trusted N5CW device 102 can support multi-PDU extensions/messaging and/or other operations with trusted WLAN 108 in accordance with embodiments herein.

In accordance with embodiments herein, PCF 116 can be enhanced to store each of a URSP envelope, referred to interchangeably herein as a ‘route selection envelope’, for each of an N5CW device that may connect to trusted WLAN 108, such as N5CW device 102. The URSP envelope for a corresponding N5CW device, such as N5CW device 102, can include multiple URSP rules (also referred to interchangeably herein as ‘route selection rules’) in which each URSP rule can include parameters that can be used, in some embodiments, for facilitating establishment of multiple PDU sessions for the N5CW device 102 and can also be used for routing data traffic for each of multiple PDU sessions that can be established for the N5CW device 102. Thus, a URSP envelope for a given N5CW device can be characterized as containing multiple URSP rules for the given N5CW device.

Generally, a URSP rule can include (e.g., as prescribed at least by 3GPP TS 24.526, 23.503, etc.) a traffic descriptor (TD) portion and a route descriptor (RD) portion. A precedence value can also be configured for a URSP rule (e.g., indicating a precedence or priority for applying the rule).

In various embodiments, the traffic descriptor (TD) portion of a URSP rule that may be configured for a given N5CW device via PCF 116 in accordance with embodiments herein may include any combination of application descriptors (e.g., an application identifier (ID) (associated with certain traffic)), IP descriptors (e.g., destination IP address, port, and/or protocol), domain descriptors (e.g., ‘example.com’, a Fully Qualified Domain Name (FQDN), etc.), DNN descriptor(s)/identifying information, non-IP descriptors, connection capabilities, and/or the like.

In various embodiments, the route descriptor (RD) portion of a URSP rule that may be configured for a given N5CW device can included one or more route descriptor (RD) parameters may include any combination of network slice information (e.g., S-NSSAI), Session and Service Continuity (SSC) mode, DNN selection/identifying information, etc.

During operation of system 100, the TWIF 106, via URSP logic 107, can obtain a URSP envelope for N5CW device 102 from PCF 116 upon successful completion of a registration and authentication procedure facilitated via TWAP 104/TWIF 106, AMF 112, and UDM 118. The TWIF 106 can store the URSP envelope for N5CW device 102. In one embodiment, the TWIF 106 can use the URSP rules of the envelope to establish each of one or more PDU sessions with the mobile core network 110 based on session/service parameters obtained from the N5CW device 102 (via TWAP 104) that are matched to a corresponding URSP rule. Thus, in at least one embodiment, the TWIF 106 can compare session/service parameters obtained from the N5CW device 102 to the URSP rules in the URSP envelope of the N5CW device 102 to confirm/identify that the N5CW device 102 is allowed to establish a given PDU session.

In at least one embodiment, the N5CW device 102 can be preconfigured with information that maps different applications (e.g., a Session Initiation Protocol (SIP) voice service application, gaming applications, video streaming applications, collaboration/teleconference applications, etc.) that can be operated/executed by the N5CW device 102 to different PDU session/service parameters that are to be utilized for a PDU session that is to be established/operated for each application. In at least one embodiment, a URSP envelope including URSP rules containing the various session/service parameters for each application that is obtained for the N5CW device 102 by the TWIF 106 can be communicated to the N5CW device 102 by the TWIF 106/TWAP 104 using an 802.11/WLAN action frame and/or an 802.11/WLAN Fast-Initial Link Setup (FILS) association response message that can be sent to the N5CW device 102.

For either embodiment (N5CW device 102 preconfigured with application to session/service parameters or N5CW device 102 obtaining a URSP envelope), the N5CW device 102, when seeking a service or PDU session (e.g., for a particular application/application traffic/communications) via mobile core network 110, can indicate the PDU session parameters, also referred to interchangeably herein as service parameters (associated with a given application), to the TWAP 104/TWIF 106, via any of an 802.11/WLAN action frame or an 802.11ai/WLAN Fast-Initial Link Setup (FILS) message, which may be characterized as service activation triggers in accordance with embodiments herein. In at least one embodiment, the session/service parameters sent by the N5CW device 102 (via an action frame or FILS message) can include any combination of a network slice identifier (e.g., S-NSSAI), a DNN identifier/indicator, and/or the like that the TWIF 106 can use to compare against TD parameters and potentially, also RD parameters, of URSP rules included in the URSP envelope for the N5CW device 102 in order to determine whether the N5CW device 102 is allowed to establish the requested PDU session. Upon identifying that the session/service parameters obtained from the N5CW device 102 match a corresponding URSP rule included in the URSP envelope for the N5CW device 102, the TWIF 106 can facilitate establishment of the PDU session indicated by the N5CW device 102 based on the parameters obtained from the N5CW device 102.

However, if the TWIF 106 does not match the session/service parameters received from the N5CW device 102 to a corresponding URSP rule included in the URSP envelope for the N5CW device 102, the TWIF 106 will not be triggered to initiate PDU session establishment for the N5CW device 102, as the N5CW device 102 is considered to not be allowed to establish such a PDU session as indicated via the session/service parameters sent by the N5CW device 102 if the parameters are not matched to a corresponding URSP rule contained in the URSP envelope obtained by the TWIF 106 for the N5CW device 102.

In some embodiments, such as for communicating such session/service parameters via a service activation trigger, such as an 802.11/WLAN action frame, the N5CW device 102 can also indicate a client identifier (ID) that it is to use in Dynamic Host Configuration Protocol (DHCP) signaling, such as for Internet Protocol (IP) address configuration for the N5CW device 102, in which each of a unique IP address can be assigned to the N5CW device 102 for each of PDU session established for the N5CW device 102 via mobile core network. Each IP address and corresponding DHCP client ID will be unique for each PDU session established via mobile core network 110 for the N5CW device 102.

In some embodiments, the N5CW device 102, when using 802.11ai/WLAN FILS signaling as a service activation trigger, can indicate the session/service parameters (for a given application) to the TWAP 104/TWIF 106 using a FILS association request message, and the network (TWIF/TWAP) can deliver an IP address configuration specific to a given DNN/PDU session for the N5CW device 102 in a FILS association response message sent to the N5CW device 102.

In at least one embodiment, the TWIF 106 can update a corresponding URSP rule that was matched to the session/service parameters received from the N5CW device 102 with the IP address that is assigned to the N5CW device 102 for the corresponding PDU session established for the N5CW device 102. For example, the TWIF 106 may update the TD parameters of the corresponding URSP rule with the IP address such that, for data plane traffic received from the N5CW device 102 that is associated with the PDU session that includes, as a source IP address, the IP address of the N5CW device 102, the TWIF 106 can identify the appropriate URSP rule and PDU session in order to route the traffic for the N5CW device 102 via the appropriate PDU session established for the N5CW device 102.

Thus, broadly, service activation triggers, such as an 802.11/WLAN action frame and/or an 802.11ai/WLAN FILS association request (among other potential signaling/messages) obtained from an N5CW device may serve as a trigger to the TWIF 106 to identify/confirm a corresponding URSP rule configured within a URSP envelope stored for the N5CW device and to initiate N1 signaling with the 5GC/AMF 112 on behalf of the N5CW device for establishing a PDU session for the N5CW device with the mobile core network 110 based on the session/service parameters received from the N5CW device 102. The TWIF 106 can establish multiple PDU sessions for an N5CW device with the mobile core network for each of multiple URSP rules included in the URSP envelope obtained for the N5CW device 102. Accordingly, embodiments herein may enable multi-PDU session support for an N5CW device in a trusted WLAN/5GC interworking architecture.

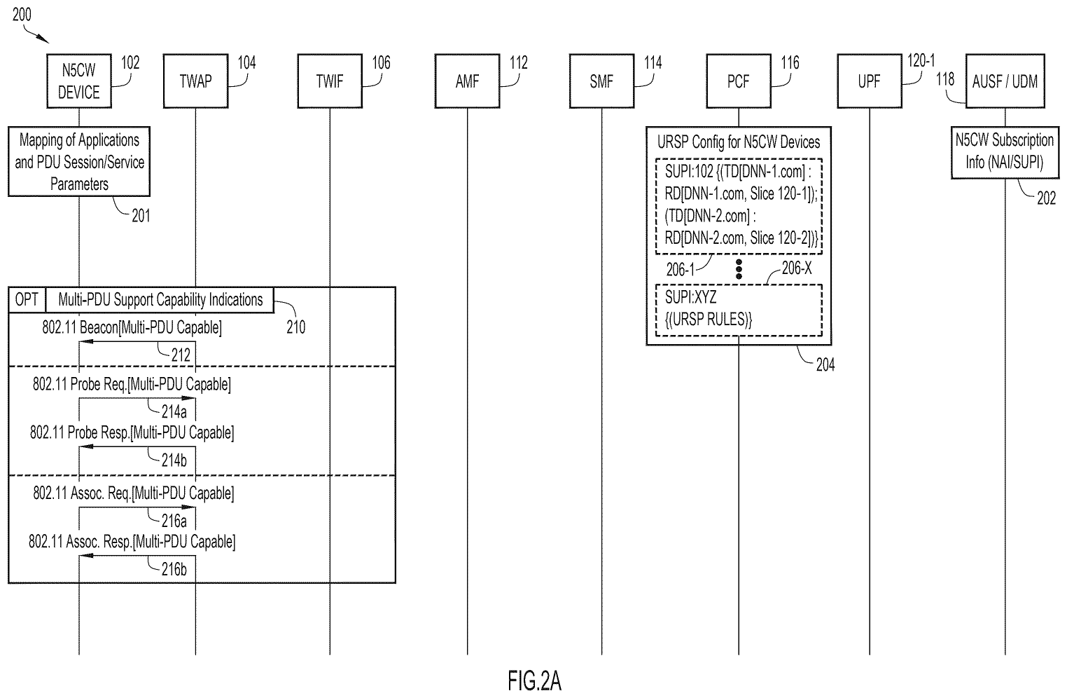

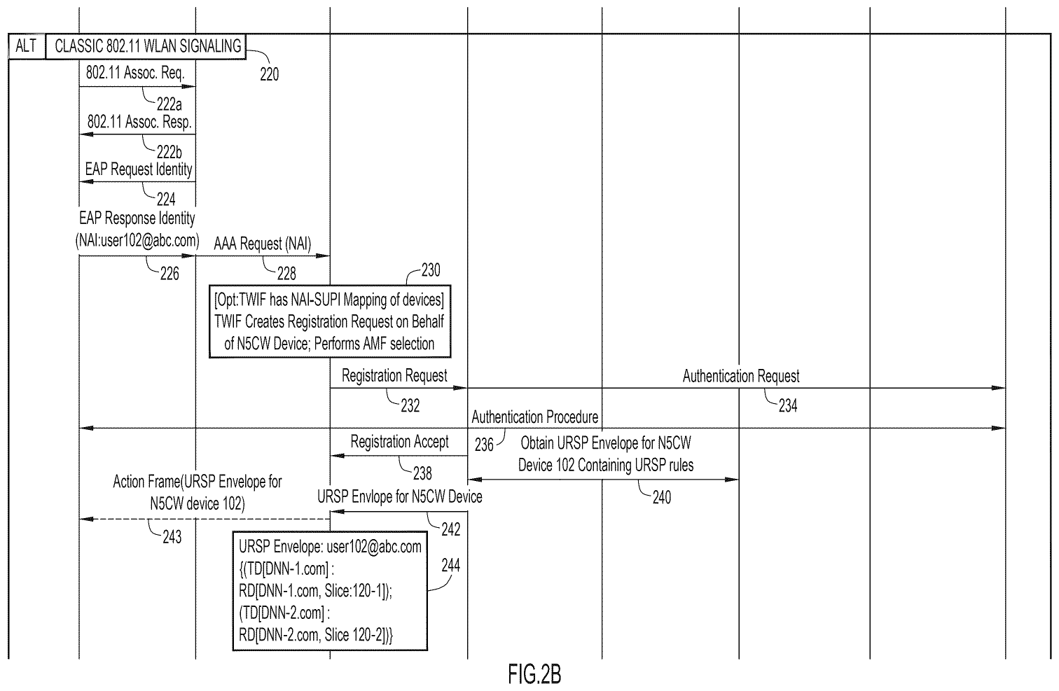

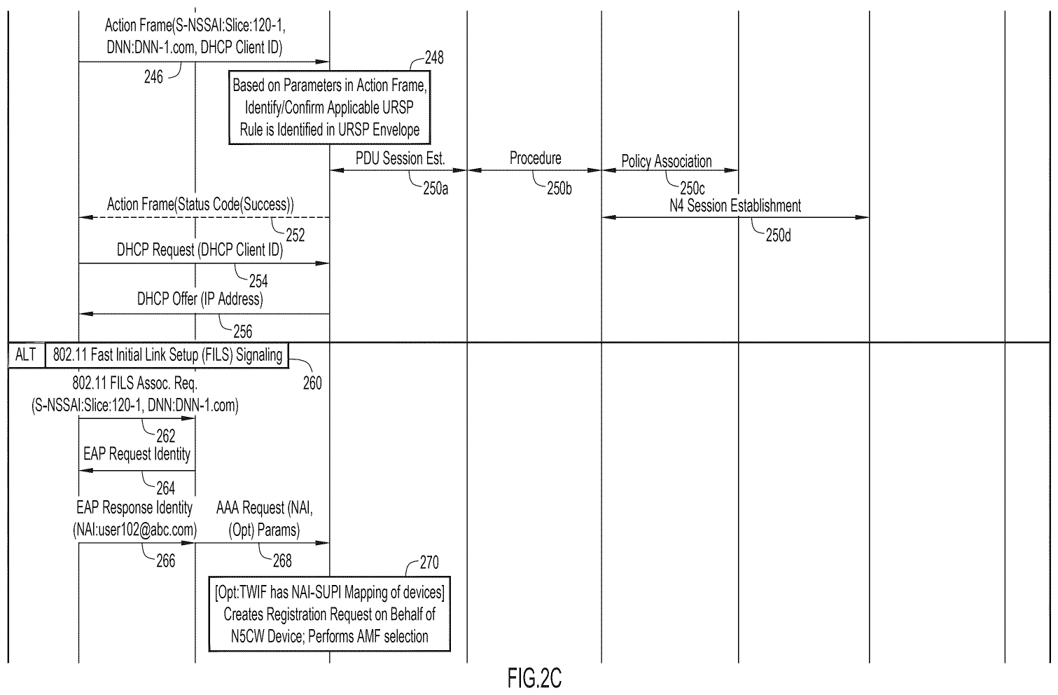

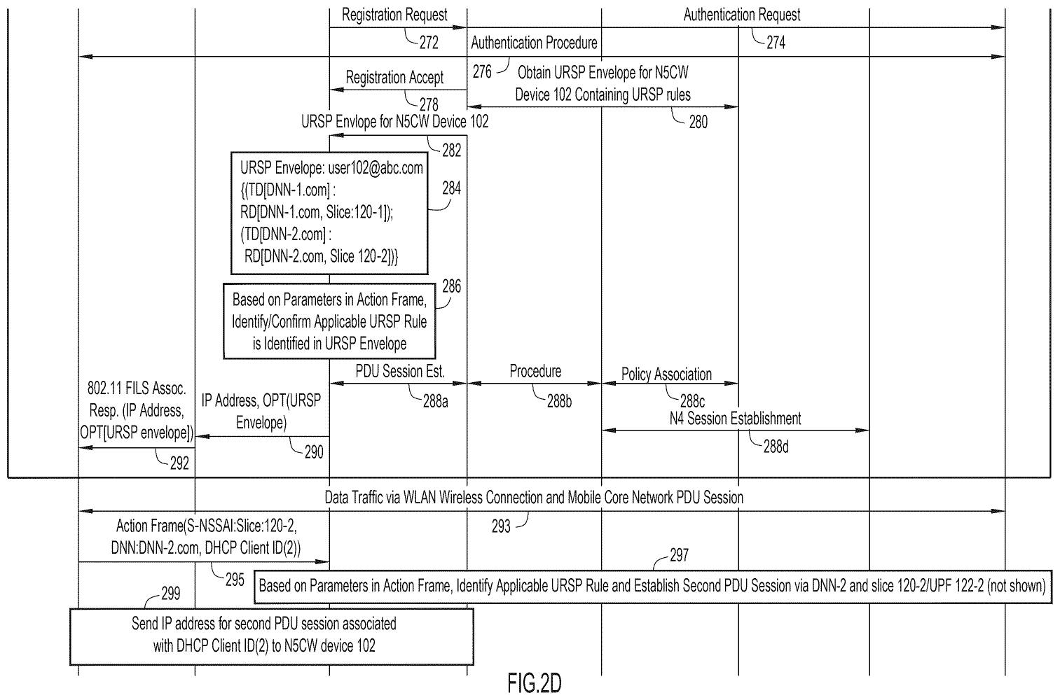

Referring to FIGS. 2A, 2B, 2C, and 2D, are a message sequence diagram 200 illustrating various example operations that can be performed to facilitate multiple sessions for an N5CW device, such as N5CW device 102, with mobile core network 110 via a trusted WLAN 108. FIGS. 2A, 2B, 2C, and 2D include N5CW device 102, TWAP 104, TWIF 106 (including URSP logic 107, not shown), AMF 112, SMF 114, PCF 116, UPF 122-1 (of slice 120-1), and AUSF/UDM 118.

For the example of FIGS. 2A-2D, consider, as shown at 201, that N5CW device 102 is configured with information that maps different applications (e.g., a Session Initiation Protocol (SIP) voice service application, gaming applications, video streaming applications, collaboration/teleconference applications, etc.) that can be operated/executed by the N5CW device 102. However, in some embodiments, the N5CW device 102 may receive such information via a URSP envelope, as discussed herein, below.

As shown at 202, consider that AUSF/UDM 118 is configured with subscription information for N5CW device 102, which may include one or more 3GPP subscription/device identifiers for N5CW device 102 and/or a user/subscriber associated therewith, such as an International Mobile Subscriber Identity (IMSI), Subscription Permanent Identifier (SUPI), Permanent Equipment Identifier (PEI), International Mobile station Equipment Identity (IMIE), and/or the like. In one example, a SUPI for N5CW device 102 may be configured as ‘SUPI:102’. The subscription information configured for N5CW device 102 may also include a WLAN identifier for the N5CW device 102, such as a Network Access Identifier (NAI). In one example, an NAI for N5CW device 102 may be configured as ‘user102@abc.com’. Other subscription information can be stored for the N5CW device 102, such as QoS parameters for different sessions that can be established for the N5CW device 102, among other information.

As discussed above, the PCF 116 can be configured with a URSP envelope containing multiple URSP rules for each N5CW device, such as N5CW device 102, that is authorized to establish multiple PDU sessions with the mobile core network 110. For example, as shown at 204, a URSP envelope 206-1 can be configured/provisioned for N5CW device 102 that identifies the SUPI for N5CW device 102 (e.g., SUPI: 102) and two URSP rules (in this example, not meant to limit embodiments herein). In some embodiments, the NAI for the N5CW device 102 (e.g., user102@abc.com) may also be stored in association with the URSP envelope 206-1.

For the URSP envelope 206-1 configured for N5CW device 102, a first URSP rule can be configured for the URSP envelope 206-1 that includes TD parameters identifying a DNN, DNN-1.com, and RD parameters identifying that a PDU session for the N5CW device 102 is to be established with DNN-1.com via slice 120-1 (slice:120-1) per the corresponding (first) URSP rule. Further, a second URSP rule can be configured for the URSP envelope 206-1 that includes TD parameters identifying a DNN, DNN-2.com, and RD parameters identifying that a PDU session for the N5CW device 102 is to be established with DNN-2.com via slice 120-2 (slice:120-2) per the corresponding (second) URSP rule. Other URSP envelope(s) 206-X including any number of URSP rule(s) can also be configured in PCF 116 for any ‘X’ number of other N5CW devices that may be authorized to establish sessions with mobile core network.

In accordance with some embodiments herein, various capability exchanges can be performed between N5CW device 102 and trusted WLAN 108, via TWAP 104, via various operations as shown at 210 of FIG. 2A, in order for the N5CW device 102 and/or the TWAP 104 to provide capability indications (to each other) indicating whether each supports multi-PDU session extensions/operations.

For example, as shown at 212, in some embodiments, TWAP 104 may communicate/transmit one or more WLAN/802.11 beacon messages that include a WLAN capability indication indicating that the trusted WLAN 108 is multi-PDU capable/capable of supporting such signaling/extensions with the N5CW device 102. In at least one embodiment, a new IE/VSIE, such as a “Multi-PDU Capable” IE/VSIE having a particular IE/VSIE Identifier (ID), can be defined for WLAN/802.11 management beacons to be transmitted by the TWAP 104 in which the IE/VSIE can be set to a value of “1” to indicate multi-PDU capability support for the trusted WLAN 108 and the value can be set to “0” or the Multi-PDU capability IE/VSIE can be excluded from beacon messages to indicate that the trusted WLAN 108 does not support the multi-PDU capability.

In some embodiments, as shown at 214a, N5CW device 102 can communicate/transmit one or more WLAN/802.11 probe request messages that include a device capability indication indicating that the N5CW device 102 is multi-PDU capable/capable of supporting such signaling/extensions with the trusted WLAN 108. In at least one embodiment, a new IE/VSIE, such as a “Multi-PDU Capable” IE/VSIE having a particular IE/VSIE ID, can be defined for WLAN/802.11 probe request messaged to be transmitted by the N5CW device 102 in which the IE/VSIE can be set to a value of “1” to indicate multi-PDU capability support for the N5CW device 102 and the value can be set to “0” or the Multi-PDU capability IE/VSIE can be excluded from probe request messages to indicate that the N5CW device 102 does not support the multi-PDU capability.

In some embodiments, as shown at 214b, TWIF 106 may communicate/transmit one or more WLAN/802.11 probe response messages that include a WLAN capability indication indicating that the trusted WLAN 108 is multi-PDU capable/capable of supporting such signaling/extensions with the N5CW device 102. In at least one embodiment, a new IE/VSIE, such as a “Multi-PDU Capable” IE/VSIE having a particular IE/VSIE ID, can be defined for WLAN/802.11 probe response messages to be transmitted by the TWAP 104 in which the IE/VSIE can be set to a value of “1” to indicate multi-PDU capability support for the trusted WLAN 108 and the value can be set to “0” or the Multi-PDU capability IE/VSIE can be excluded from probe response messages to indicate that the trusted WLAN 108 does not support the multi-PDU capability.

In some embodiments, as shown at 216a, N5CW device 102 can communicate/transmit one or more WLAN/802.11 association request messages that include a device capability indication indicating that the N5CW device 102 is multi-PDU capable/capable of supporting such signaling/extensions with the trusted WLAN 108. In at least one embodiment, a new IE/VSIE, such as a “Multi-PDU Capable” IE/VSIE having a particular IE/VSIE ID for a tagged parameter, can be defined for WLAN/802.11 association request messages to be transmitted by the N5CW device 102 in which the IE/VSIE can be set to a value of “1” to indicate multi-PDU capability support for the N5CW device 102 and the value can be set to “0” or the Multi-PDU capability IE/VSIE can be excluded from association request messages to indicate that the N5CW device 102 does not support the multi-PDU capability.

In some embodiments, as shown at 216b, TWIF 106 may communicate/transmit one or more WLAN/802.11 probe response messages that include a WLAN capability indication indicating that the trusted WLAN 108 is multi-PDU capable/capable of supporting such signaling/extensions with the N5CW device 102. In at least one embodiment, a new IE/VSIE, such as a “Multi-PDU Capable” IE/VSIE having a particular IE/VSIE ID for a tagged parameter, can be defined for WLAN/802.11 association response messages to be transmitted by the TWAP 104 in which the IE/VSIE can be set to a value of “1” to indicate multi-PDU capability support for the trusted WLAN 108 and the value can be set to “0” or the Multi-PDU capability IE/VSIE can be excluded from association response messages to indicate that the trusted WLAN 108 does not support the multi-PDU capability.

In some embodiments, any combination of capability exchanges/transmissions between a trusted WLAN (TWAP) and a given N5CW device can be used to enable both the TWAP/TWIF and the N5CW device to utilize various multi-PDU session messaging/signaling/operations for establishing PDU sessions via a mobile core network in accordance with embodiments herein.

However, in some embodiments, a trusted WLAN and N5CW devices can be configured to understand that various multi-PDU session messaging/signaling/operations for establishing PDU sessions via a mobile core network are supported, by default for a given trusted WLAN and a given mobile core network such that various capability exchanges/transmissions as shown at 210 may not be needed. For example, in some embodiments, N5CW devices may be configured with trusted WLAN identifying information (e.g., Basic Service Set Identifiers (BSSIDs), Service Set Identifiers (SSIDs), etc.) for one or more trusted WLAN(s) in combination with an indication that such trusted WLAN(s) support multi-PDU session messaging/signaling/operations, such that capability exchanges/transmissions with the trusted WLAN(s) may not be needed.

Moving to FIGS. 2B, 2C, and 2D, consider various signaling/operations through which at least one PDU session can be established for N5CW device 102 via mobile core network 110 in accordance with embodiments herein. For example, FIGS. 2B and 2C illustrate various signaling/operations 220 through which classic 802.11/WLAN signaling can be utilized between N5CW device 102 and the TWAP 104/TWIF 106 for PDU session establishment with mobile core network 110 in accordance with embodiments herein.

As shown at 222a, consider that N5CW device 102 communicates/transmits an 802.11 association request message towards TWAP 104, to which TWAP 104 responds with an 802.11 association response message towards N5CW device 102, as shown 222b. As shown at 224, TWAP 104 sends an Extensible Authentication Protocol (EAP) request identity message towards N5CW device 102 to request an EAP identity for the N5CW device 102 for authenticating connection of the N5CW device 102 with the TWAP 104.

As shown at 226, N5CW device 102 sends an EAP response identity message to TWAP 104 including the NAI for the N5CW device 102 (e.g., user102@abc.com), which triggers TWAP 104 to send an AAA request to TWIF 106, as shown at 228, including the NAI for the N5CW device 102.

As shown at 230, receiving the AAA request triggers the TWIF 106 to create/generate a registration request and select an AMF, AMF 112 in this example, to which to send the registration request (as shown at 232) on behalf of the N5CW device 102 in order to trigger a registration and authentication procedure for the N5CW device 102 with mobile core network 110. In some embodiments, the registration request may include the NAI for the N5CW device 102. In some embodiments, the TWIF 106 may be configured with and/or otherwise obtain an NAI-to-SUPI mapping for the N5CW device 102 such that the registration request may include the SUPI for the N5CW device 102 (e.g., SUPI:102).

Upon obtaining the registration request, the AMF 112 is triggered to initiate an authentication process for the N5CW device 102 by generating and sending, as shown at 234, an authentication request towards AUSF/UDM 118 (including the NAI or SUPI for the N5CW device 102), which triggers the AUSF/UDM 118 to perform an authentication procedure with the N5CW device 102, as generally shown at 236. The authentication procedure may be performed in a manner as understood by a person having skill in the art, such as, for example, performed in accordance with 3GPP standards.

Upon successful completion of the registration and authentication procedure with the N5CW device 102 and the mobile core network 110 (e.g., the N5CW device 102 is successfully registered and authenticated to connect to the mobile core network 110), the AMF 112 generates and sends a registration accept message (including the NAI or the SUPI for the N5CW device 102) to the TWIF 106, as shown at 238.

Further, upon successful completion of the registration and authentication procedure with the N5CW device 102 and the mobile core network 110, the AMF 112 obtains the URSP envelope 206-1 containing the URSP rules for the N5CW device 102, as shown at 240. As shown at 242, the AMF 112 sends the URSP envelope 206-1 for the N5CW device 102 to the TWIF 106, which the TWIF 106 stores, as generally shown at 244. The URSP envelope 206-1 can be stored in association with the NAI for the N5CW device 102 (e.g., user102@abc.com) and also, in some embodiments, in association with the SUPI for the N5CW device 102 (e.g., SUPI:102).

In at least one embodiment, the TWIF 106 may send the URSP envelope 206-1 for the N5CW device 102 to the N5CW device 102 via a WLAN/802.11 action frame that can be transmitted to the N5CW device 102, as shown at 243. In at least one embodiment, even if the N5CW device 102 is preconfigured with a mapping of application to session/service parameters, sending the network provided URSP envelope to the N5CW device 102 may be useful for updating the session/service parameters that the N5CW device 102 is to use for requesting PDU sessions for different applications.

Moving to FIG. 2C, at 246, the N5CW device 102, when seeking to establish a PDU session (for a particular application/application communications) with the mobile core network 110 in accordance with embodiments herein, can transmit a service activation trigger towards the TWIF 106, such as transmitting an action frame towards the TWIF 106 (via TWAP 104) that, along with the NAI for the N5CW device 102 (not shown at 246), includes various session/service parameters associated with the PDU session that the N5CW device 102 seeks to establish, such as a slice identifier identifying slice 120-1 (S-NSSAI:slice:120-1) and a DNN identifier (DNN-1.com), and also includes a DHCP client ID for the N5CW device 102 (e.g., ‘DHCPID(0102.1)’, in this example) that is to be associated with the PDU session to be established for the N5CW device 102.

As generally shown at 248, the TWIF 106 can use session/service parameters included in the action frame to identify/confirm (e.g., via URSP logic 107) that a URSP rule included in the URSP envelope 206-1, such as the first URSP rule included in the URSP envelope 206-1 including TD [DNN-1.com]:RD [DNN-1.com, slice:120-1], can be matched to the session/service parameters obtained from the N5CW device 102. Upon identifying/confirming that a URSP rule included in the URSP envelope 206-1 for the N5CW device 102 can be matched against the session/service parameters obtained from the N5CW device 102, such as the first URSP rule included in the URSP envelope 206-1, the TWIF 106 can trigger a PDU session establishment procedure for the N5CW device 102 with mobile core network 110 based on the session/service parameters obtained from the N5CW device 102, as generally shown at 250a (PDU session establishment request/response involving AMF 112), 250b (PDU session establishment request/response involving SMF 114), 250c (policy association involving PCF 116), and 250d (N4 session establishment involving SMF 114/UPF 122-1 for slice 120-1/DNN-1 (as identified in the parameters received from the N5CW device 102)). The PDU session establishment procedure performed within the mobile core network 110 may be performed in a manner as understood by a person having skill in the art, such as, for example, performed in accordance with 3GPP standards.

Thus, in at least one embodiment, the TWIF 106 may operate as a ‘gatekeeper’ for ensuring that any PDU sessions sought by the N5CW device are allowed to be established for the N5CW device based on identifying a corresponding URSP rule that includes parameters that match those indicated by the N5CW device.

In at least one embodiment, the TWIF 106, via the TWAP 104, can send a confirmation to the N5CW device 102 indicating success or failure of establishment of the PDU session sought to be established by the N5CW device 102. In at least one embodiment, as shown at 252, an action frame including a status code indicating “success” can be sent to the N5CW device 102 to indicate successful PDU session establishment based on the session/service parameters sent by the N5CW device 102.

Through the PDU session establishment, an IP address is assigned to the N5CW device 102 for the PDU session (e.g., by the SMF 114/UPF 122-1). The IP address assigned to the N5CW device 102 (which may be an IP version 4 (Ipv4) or an IP version 6 (Ipv6) address) can be stored by the TWIF 106 in association with the DHCP client ID that was included in the action frame sent by the N5CW device 102 (e.g., DHCPID(0102.1), in this example).

In at least one embodiment, the TWIF 106 can update the corresponding URSP rule that was matched to the session/service parameters received from the N5CW device 102 with the IP address that is assigned to the N5CW device 102 for the corresponding PDU session established for the N5CW device 102. For example, the TWIF 106 may update the TD parameters of the (first) URSP rule that was matched to the DNN-1.com/slice120-1 parameters received from the N5CW device 102 with the IP address for the established PDU session such that, for data plane traffic received from the N5CW device 102 that is associated with the PDU session that includes, as a source IP address, the IP address of the N5CW device 102, the TWIF 106 can identify the appropriate (first) URSP rule and PDU session in order to route the traffic for the N5CW device 102 via the appropriate PDU session established for the N5CW device 102.

Thereafter, as shown at 254, the N5CW device 102 can request the IP address for the PDU session by sending a DHCP request message to the TWIF 106 (via the TWAP 104) that includes the DHCP client ID that was included in the action frame sent by the N5CW device 102 (e.g., DHCPID(0102.1), in this example) to which the TWIF 106 can response with a DHCP offer message, as shown at 256, that includes the IP address assigned to the N5CW device 102 for the PDU session.

Following the PDU session establishment, data traffic can be communicated between the N5CW device 102 and the mobile core network via the trusted WLAN 108 connection and the mobile core network 110 PDU session, as generally shown at 293 of FIG. 2D. As discussed above, the TWIF 106 can utilize the (first) URSP rule for the PDU session established for the N5CW device 102 to route the traffic received from the N5CW device 102 to the appropriate PDU session.

FIGS. 2C and 2D illustrate other signaling/operations 260 though which 802.11 FILS signaling can be utilized between the N5CW device 102 and the TWAP 104/TWIF 106 for PDU session establishment in accordance with embodiments herein. The signaling/operations 260 shown in FIGS. 2C and 2D are illustrated under an assumption that the signaling/operations 220 associated with the classic 802.11/WLAN signaling discussed above are not performed prior to the signaling/operations 260 associated with the 802.11 FILS signaling that can be used as a service activation trigger for PDU session establishment by the N5CW device 102.

For the 802.11 FILS signaling, consider in at least one embodiment, as shown at 262, that N5CW device 102 communicates/transmits an 802.11 FILS association request message to the TWAP 104 that includes various session/service parameters associated with the PDU session that the N5CW device 102 seeks to establish, such as a slice identifier identifying slice 120-1 (S-NSSAI:slice:120-1) and a DNN identifier (DNN-1.com).

As shown at 264, TWAP 104 sends an EAP request identity message towards N5CW device 102 to request an EAP identity for the N5CW device 102 for authenticating connection of the N5CW device 102 with the TWAP 104. As shown at 266, N5CW device 102 sends an EAP response identity message to TWAP 104 including the NAI for the N5CW device 102 (e.g., user102@abc.com), which triggers TWAP 104 to send an AAA request to TWIF 106 including the NAI for the N5CW device 102, as shown at 268. In at least one embodiment, If the TWAP 104 and TWIF 106 are implemented as collocated/combined element, the TWAP 104 can relay the session/service parameters to the TWIF 106 via internal logic. In at least one embodiment, the AAA request sent to the TWIF 106 by the TWAP 104 may further include the session/service parameters (S-NSSAI: slice:120-1) and DNN-1.com) that the N5CW device 102 sent to the TWAP 104 in the FILS association request message. In at least one embodiment, the TWAP 104 may send the session/service parameters to the TWIF via a protocol such as the Control and Provisioning of Wireless Access Points (CAPWAP) protocol. In at least one embodiment, the TWAP 104 may send the session/service parameters to the TWIF 106 through vendor-defined or standards-defined messaging/signaling.

As shown at 270, receiving the AAA request triggers the TWIF 106 to create/generate a registration request and select an AMF, AMF 112 in this example, to which to send the registration request (as shown at 272 of FIG. 2D) on behalf of the N5CW device 102 in order to trigger a registration and authentication procedure for the N5CW device 102 with mobile core network 110. In some embodiments, the registration request may include the NAI for the N5CW device 102. In some embodiments, the TWIF 106 may be configured with and/or otherwise obtain an NAI-to-SUPI mapping for the N5CW device 102 such that the registration request may include the SUPI for the N5CW device 102 (e.g., SUPI:102).

Upon obtaining the registration request, the AMF 112 is triggered to initiate an authentication process for the N5CW device 102 by generating and sending, as shown at 274, an authentication request towards AUSF/UDM 118 (including the NAI or SUPI for the N5CW device 102), which triggers the AUSF/UDM 118 to perform an authentication procedure with the N5CW device 102, as generally shown at 276. The authentication procedure may be performed in a manner as understood by a person having skill in the art, such as, for example, performed in accordance with 3GPP standards.

Upon successful completion of the registration and authentication procedure with the N5CW device 102 and the mobile core network 110 (e.g., the N5CW device 102 is successfully registered and authenticated to connect to the mobile core network 110), the AMF 112 generates and sends a registration accept message (including the NAI or the SUPI for the N5CW device 102) to the TWIF 106, as shown at 278.

Further, upon successful completion of the registration and authentication procedure with the N5CW device 102 and the mobile core network 110, the AMF 112 obtains the URSP envelope 206-1 containing the URSP rules for the N5CW device 102, as shown at 280. As shown at 282, the AMF 112 sends the URSP envelope 206-1 for the N5CW device 102 to the TWIF 106, which the TWIF 106 stores, as generally shown at 284. The URSP envelope 206-1 can be stored in association with the NAI for the N5CW device 102 (e.g., user102@abc.com) and also, in some embodiments, in association with the SUPI for the N5CW device 102 (e.g., SUPI:102).

With regard to the 802.11 FILS signaling/operations in this example, as shown at 286, the TWIF 106 can use session/service parameters that the N5CW device 102 included in the 802.11 FILS association request (sent to the TWIF 106 at 262 and communicated to the TWAP 104 using various techniques, as discussed above) in order to identify/confirm (via URSP logic 107) that a URSP rule included in the URSP envelope 206-1, such as the first URSP rule included in the URSP envelope 206-1 including TD [DNN-1.com]:RD [DNN-1.com, slice:120-1], can be matched to the session/service parameters obtained from the N5CW device 102. Upon identifying/confirming that a URSP rule included in the URSP envelope for the N5CW device 102 can be matched against the session/service parameters obtained from the N5CW device 102, the TWIF 106 can trigger a PDU session establishment procedure for the N5CW device 102 with mobile core network 110 based on the session/service parameters obtained from the N5CW device 102, as generally shown at 288a (PDU session establishment request/response involving AMF 112), 288b (PDU session establishment request/response involving SMF 114), 288c (policy association involving PCF 116), and 288d (N4 session establishment involving SMF 114/UPF 122-1 for slice 120-1/DNN-1 (as identified in the parameters received from the N5CW device 102)). The PDU session establishment procedure performed within the mobile core network 110 may be performed in a manner as understood by a person having skill in the art, such as, for example, performed in accordance with 3GPP standards.

Through the PDU session establishment, an IP address is assigned to the N5CW device 102 for the PDU session. Upon establishment of the PDU session for the N5CW device 102, as shown at 290, the TWIF 106 can communicate the IP address for the N5CW device 102 for the PDU session to the TWAP 104 (e.g., via CAPWAP or some other signaling if not collocated), which can communicate the IP address to the N5CW device 102 via an 802.11 FILS association response message, as shown at 292. In at least one embodiment, the URSP envelope 206-1 for the N5CW device 102 obtained by the TWIF 106 can also be sent to the N5CW device 102 via the FILS association response message. In at least one embodiment, the TWIF 106 can update the corresponding URSP rule that was matched to the session/service parameters received from the N5CW device 102 with the IP address that is assigned to the N5CW device 102 for the corresponding PDU session established for the N5CW device 102.

Following the PDU session establishment, data traffic can be communicated between the N5CW device 102 and the mobile core network via the trusted WLAN 108 connection and the mobile core network 110 PDU session, as generally shown at 293 of FIG. 2D. As discussed above, the TWIF 106 can utilize the (first) URSP rule for the PDU session established for the N5CW device 102 to route the traffic received from the N5CW device 102 to the appropriate PDU session.

Consider further as shown in FIG. 2D that in one instance, the N5CW device 102 seeks to establish a second PDU session that is to be utilized concurrent with the first session involving DNN-1.com and slice 120-1 in which the N5CW device 102 seeks to establish the second session (for another application/application communications) for another DNN and slice, such as DNN-2.com and slice 120-2. In at least one embodiment, the N5CW device 102 can send another action frame towards the TWIF 106 (via TWAP 104, as shown at 295 that, along with the NAI for the N5CW device 102 (not shown at 293), includes various session/service parameters associated with the second PDU session that the N5CW device 102 seeks to establish, such as a slice identifier identifying slice 120-2 (S-NSSAI:slice:120-2) and a DNN identifier (DNN-2.com), and also includes another/second DHCP client ID for the N5CW device 102, (e.g., ‘DHCPID(0102.2)’, in this example) that is to be associated with the second PDU session to be established for the N5CW device 102. Although an action frame is shown for requesting the second PDU session, in some embodiments, the N5CW device 102 can send another FILS association request message to the TWAP 104 for requesting the second PDU session establishment.

As generally shown at 297, the TWIF 106 can use session/service parameters included in the action frame to identify/confirm (e.g., via URSP logic 107) that a URSP rule included in the URSP envelope 206-1, such as the second URSP rule included in the URSP envelope 206-1 including TD [DNN-2.com]:RD[DNN-2.com, slice:120-2], can be matched to the session/service parameters obtained from the N5CW device 102. Upon identifying/confirming that a URSP rule included in the URSP envelope 206-1 for the N5CW device 102 can be matched against the session/service parameters obtained from the N5CW device 102, such as the second URSP rule included in the URSP envelope 206-1, the TWIF 106 can trigger a second PDU session establishment procedure for the N5CW device 102 with mobile core network 110 based on the session/service parameters obtained from the N5CW device 102, similar to operations 250a, 250b, 250c, and 250d but involving N4 session establishment involving SMF 114/UPF 122-2 for slice 120-2/DNN-2, as identified in the parameters received from the N5CW device 102, although UPF 122-2 is not shown in FIG. 2D.

Through the second PDU session establishment, an IP address is assigned to the N5CW device 102 for the second PDU session. The IP address assigned to the N5CW device 102 (which may be an IPV4 or an IPV6 address) can be stored by the TWIF 106 in association with the another/second DHCP client ID that was included in the action frame sent by the N5CW device 102 (e.g., DHCPID(0102.2), in this example). In at least one embodiment, the TWIF 106 can update the corresponding URSP rule that was matched to the session/service parameters received from the N5CW device 102 with the IP address that is assigned to the N5CW device 102 for the corresponding PDU session established for the N5CW device 102.

Thereafter, as generally shown at 299, the IP address assigned to the N5CW device 102 for the second PDU session can be sent to the N5CW device 102 via another DHCP request/offer exchange between the N5CW device 102 and the TWAP 104/TWIF 106. Although not shown in FIG. 2D, following the second PDU session establishment, data traffic can be communicated between the N5CW device 102 and the mobile core network via the trusted WLAN 108 connection and the mobile core network 110 second PDU session. The TWIF 106 can utilize the (second) URSP rule for the PDU session established for the N5CW device 102 to route the traffic received from the N5CW device 102 to the appropriate PDU session.

Although not shown in FIGS. 2A-2D, embodiments herein may support PDU session deactivation for N5CW device 102 through various operations. For example, in at least one embodiment, the N5CW device 102 could send a WLAN/802.11 action frame with a specific action trigger indicating deactivation (e.g., activation trigger=deactivation), and by including the parameters for identifying the PDU session, the TWIF 106, on receiving this specific action frame could deactivate the identified PDU session.

In another embodiment, if/when the TWIF 106 determines that there is no active traffic from the N5CW device 102 for a given PDU session for a threshold duration of time (which can be based on a configuration parameter, which could be configured for the TWIF 106 and/or could be identified via subscription information for the N5CW device 102 contained in the UDM 118), then the TWIF could deactivate the given PDU session.

In another embodiment, on determination that the N5CW device 102 is no longer associated with the TWAP 104 (e.g., the N5CW device 102 is disassociated with TWAP 104), the TWAP 104 can signal the TWIF 106 for PDU session deactivation, potentially for all the PDU session(s) that may have been established for the N5CW device 102. In various embodiments, TWIF 106 could be notified by the TWAP 104 that the N5CW device 102 is disassociated from the TWAP 104 or could determine the disassociation through other mechanisms, which could trigger the TWIF to deactivate the corresponding PDU session(s) for the N5CW device 102.

Accordingly, as shown in FIGS. 2A, 2B, 2C, and 2D, embodiments herein may facilitate multi-PDU support for an N5CW device for scenarios in which the device may interface with a mobile core network via a trusted WLAN.

Although the example operations discussed for FIGS. 2A, 2B, 2C, and 2D involve the TWIF 106 operating as a ‘gatekeeper’ for ensuring that any PDU sessions sought by the N5CW device are allowed to be established for the N5CW device based on identifying a corresponding URSP rule that includes parameters that match those indicated by the N5CW device, in some embodiments, such as if a URSP envelope for a given N5CW device is sent to the given N5CW device (via an action frame or FILS association response, the ‘gatekeeper’ operations performed may be configured to be performed or not be performed by the TWIF 106 by a network operator.

In various embodiments, the network operator may signal to the TWIF 106 (e.g., from the AMF 112, via an indication included in the URSP envelope configured for a given N5CW device [e.g., send to device=1, exclude received parameter check=1], etc.) that the TWIF 106 is to send the URSP envelope to the given N5CW device 102 and thereafter is not to perform the identifying/matching operations upon receiving session/service parameters from the given N5CW device (to confirm that a corresponding session is allowed for the given N5CW device), but rather initiate PDU session establishment directly in accordance with the session/service parameters received from the given N5CW device. The TWIF 106 may still use the URSP envelope for the given N5CW device to perform routing for data traffic to appropriate PDU sessions.

Other variations can be envisioned. For example, in some embodiments, the TWIF 106 can be configured to send the URSP envelope for a given N5CW device to the device, but still perform checks against the URSP envelope stored by the TWIF 106 to confirm that the given N5CW device is allowed to establish a certain PDU session (e.g., send to device=1, exclude received parameter check=0). Such operations may be useful to address situations in which there may be a concern of an N5CW device or user thereof from adjusting/modifying parameters of URSP rules assigned to the N5CW device.

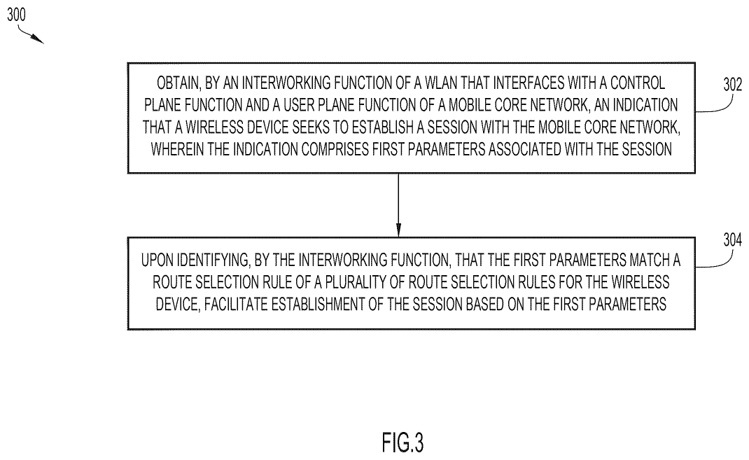

Referring to FIG. 3, FIG. 3 is a flow chart depicting a method 300 according to an example embodiment. In at least one embodiment, method 300 illustrates operations that may be performed by a trusted WLAN interworking function of a trusted WLAN, such as TWIF 106, in order to facilitate multiple PDU sessions for a wireless device, such as N5CW device 102, with a mobile core network service via a trusted WLAN, such as trusted WLAN 108. In at least one embodiment, method 300 may be associated with operations in which the TWIF 106 may operate as a ‘gatekeeper’ for ensuring that any PDU sessions sought by an N5CW device are allowed to be established for the N5CW device.

As shown at 302, the method may include obtaining, by an interworking function of a WLAN (e.g., TWIF 106 of trusted WLAN 108) that interfaces with a control plane function (e.g., AMF 112) and a user plane function (e.g., UPF 122-1) of a mobile core network, an indication that a wireless device seeks to establish a session with the mobile core network, wherein the indication comprises first parameters associated with the session. The wireless device may be a wireless device that is not capable of Non-Access-Stratum (NAS) signaling with the mobile core network via the WLAN (e.g., the wireless device may be an N5CW device, as discussed for embodiments herein).

In at least one embodiment, the indication may be obtained by the interworking function based on a WLAN action frame transmitted by the wireless device in which the WLAN action frame includes the first parameters. In at least one embodiment, the WLAN action frame may further include an identifier for the wireless device to be used for Dynamic Host Configuration Protocol signaling for the wireless device. In at least one embodiment, the indication may be obtained by the interworking function based on a WLAN Fast-Initial Link Setup (FILS) association request transmitted by the wireless device in which the WLAN FILS association request includes the first parameters. In at least one embodiment, the first parameters may include a network slice identifier and a data network name (DNN) identifier.

At 304, the method may include upon identifying, by the interworking function, that the first parameters match a route selection rule of a plurality of route selection rules for the wireless device, facilitating establishment of the session with the mobile core network based on the first parameters.

The route selection rule may be a URSP rule of a URSP envelope for the wireless device obtained by the interworking function. The URSP envelope containing the URSP rules may be obtained by the interworking function upon registration and authentication of the wireless device with the mobile core network.

The method may include providing an Internet Protocol (IP) address for the wireless device for the session established with the mobile core network.

Although not shown in FIG. 3, in some embodiments the method may include obtaining, by the interworking function, a device capability indication indicating that the wireless device is capable of providing protocol data unit (PDU) session establishment parameters to the WLAN (e.g., for establishing one or more PDU sessions with the mobile core network)/is capable of handling multi-PDU signaling extensions. In some instances, the device capability indication is obtained based on at least one of a WLAN association request transmission or a WLAN probe request transmission by the wireless device.

In still some embodiments, the method may include providing, to the wireless device, a WLAN capability indication indicating that the WLAN is capable of establishing multiple PDU sessions with the mobile core network for the wireless device/is capable of handling multi-PDU signaling extensions. In some instances, the WLAN capability indication is provided to the wireless device via at least one of a WLAN beacon transmission, a WLAN probe response transmission, or a WLAN association response transmission from an access point of the WLAN that interfaces with the interworking function.

Further, in still some embodiments, the method may further include obtaining, by the interworking function, another indication that the wireless device seeks to establish another session with the mobile core network in which the another indication comprises second parameters associated with the another session; and upon identifying, by the interworking function and based on the second parameters, another route selection rule of a plurality of route selection rules for the wireless device, facilitating, by the interworking function, establishment of the another session with the mobile core network based on the second parameters.

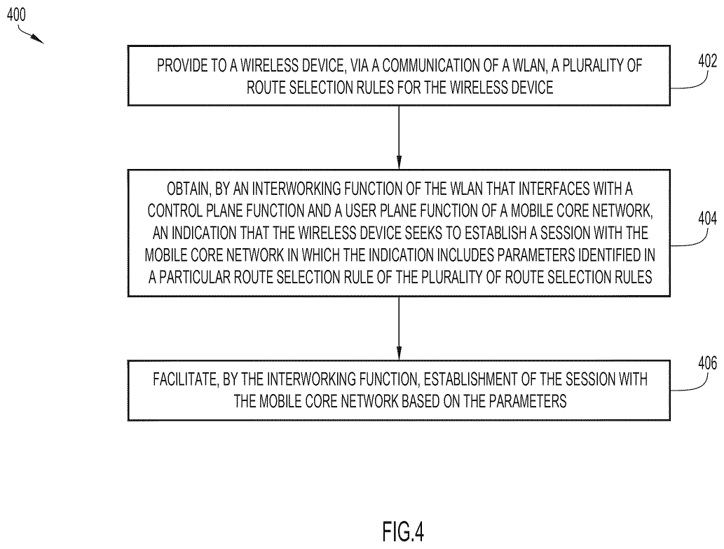

Referring to FIG. 4, FIG. 4 is a flow chart depicting a method 400 according to an example embodiment. In at least one embodiment, method 400 illustrates operations that may be performed by a trusted WLAN interworking function of a trusted WLAN, such as TWIF 106, in order to facilitate multiple PDU sessions for a wireless device, such as N5CW device 102, with a mobile core network service via a trusted WLAN, such as trusted WLAN 108. In at least one embodiment, method 400 may be associated with operations in which the TWIF 106 may not operate as a ‘gatekeeper’ for ensuring that any PDU sessions sought by an N5CW device are allowed to be established for the N5CW device, but rather may directly facilitate establishment of PDU sessions for the N5CW device based on parameters received from the N5CW device.

As shown at 402, the method may include providing, to a wireless device via a communication of a WLAN, a plurality of route selection rules for the wireless device. The wireless device may be a wireless device that is not capable of Non-Access-Stratum (NAS) signaling with the mobile core network via the WLAN (e.g., the wireless device may be an N5CW device, as discussed for embodiments herein). In various embodiments, the communication of the WLAN may be an 802.11/WLAN action frame transmitted to the wireless device (via a TWAP) including the plurality of route selection rules or may be an 802.11/WLAN FILS association response message transmitted to the wireless device including the plurality of route selection rules.

At 404, the method may include, obtaining, by an interworking function of the WLAN that interfaces with a control plane function and a user plane function of a mobile core network, an indication that the wireless device seeks to establish a session with the mobile core network in which the indication includes parameters identified in a particular route selection rule of the plurality of selection rules.

In at least one embodiment, the indication may be obtained by the interworking function based on a WLAN action frame transmitted by the wireless device in which the WLAN action frame includes the parameters. In at least one embodiment, the WLAN action frame may further include an identifier for the wireless device to be used for Dynamic Host Configuration Protocol signaling for the wireless device. In at least one embodiment, the indication may be obtained by the interworking function based on a WLAN Fast-Initial Link Setup (FILS) association request transmitted by the wireless device in which the WLAN FILS association request includes the parameters. In at least one embodiment, parameters may include a network slice identifier and a data network name (DNN) identifier.

The particular route selection rule may be a URSP rule of a URSP envelope for the wireless device obtained by the interworking function. The URSP envelope containing the URSP rules may be obtained by the interworking function upon registration and authentication of the wireless device with the mobile core network.

At 406, the method may include, facilitating, by the interworking function, establishment of the session with the mobile core network based on the parameters.

The method may include providing an Internet Protocol (IP) address for the wireless device for the session established with the mobile core network.

Although not shown in FIG. 4, in some embodiments the method may include obtaining, by the interworking function, a device capability indication indicating that the wireless device is capable of providing protocol data unit (PDU) session establishment parameters to the WLAN (e.g., for establishing one or more PDU sessions with the mobile core network)/is capable of handling multi-PDU signaling extensions. In some instances, the device capability indication is obtained based on at least one of a WLAN association request transmission or a WLAN probe request transmission by the wireless device.

In still some embodiments, the method may include providing, to the wireless device, a WLAN capability indication indicating that the WLAN is capable of establishing multiple PDU sessions with the mobile core network for the wireless device/is capable of handling multi-PDU signaling extensions. In some instances, the WLAN capability indication is provided to the wireless device via at least one of a WLAN beacon transmission, a WLAN probe response transmission, or a WLAN association response transmission from an access point of the WLAN that interfaces with the interworking function.

Further, in still some embodiments, the method may further include obtaining, by the interworking function, another indication that the wireless device seeks to establish another session with the mobile core network in which the another indication comprises second parameters associated with the another session; and facilitating, by the interworking function, establishment of the another session with the mobile core network based on the second parameters.

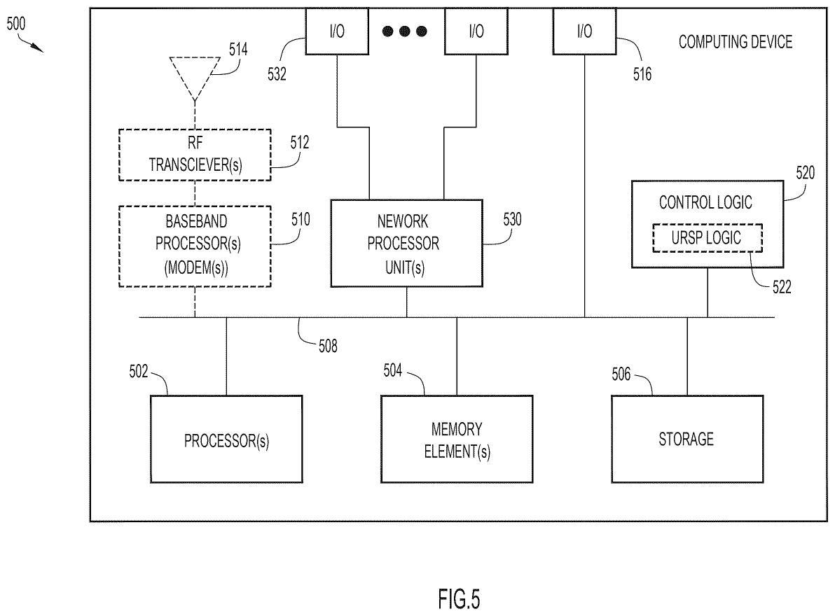

Referring to FIG. 5, FIG. 5 illustrates a hardware block diagram of a computing device 500 that may perform functions associated with operations discussed herein in connection with the techniques described for embodiments herein. In various embodiments, a computing device or apparatus, such as computing device 500 or any combination of computing devices 500, may be configured as any entity/entities in order to perform operations of the various techniques discussed for embodiments herein, such as any elements, functions, etc. discussed for embodiments herein.

In at least one embodiment, the computing device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520, which may include URSP logic 522 for embodiments in which computing device 500 is implemented as a TWIF or a combined TWAP/TWIF. In various embodiments, instructions associated with logic for computing device 500 can overlap in any manner and are not limited to the specific allocation of instructions and/or operations described herein.

For embodiments in which computing device 500 may be implemented as any device capable of wireless communications, computing device 500 may further include at least one baseband processor or modem 510, one or more radio RF transceiver(s) 512 (e.g., any combination of RF receiver(s) and RF transmitter(s)), one or more antenna(s) or antenna array(s) 514.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520 and URSP logic 522) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between computing device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information (wired and/or wirelessly) in a network environment.

I/O interface(s) 516 allow for input and output of data and/or information with other entities that may be connected to computing device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 500 is implemented as a wireless device or any apparatus capable of wireless communications, the RF transceiver(s) 512 may perform RF transmission and RF reception of wireless signals via antenna(s)/antenna array(s) 514, and the baseband processor or modem 510 performs baseband modulation and demodulation, etc. associated with such signals to enable wireless communications for computing device 500.

In various embodiments, control logic 520 (and URSP logic 522, for embodiments in which computing device is implemented as a TWIF or a combined TWAP/TWIF) can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520 and URSP logic 522) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may facilitate multiple PDU sessions for/on a wireless device, such as an N5CW device, with a mobile core network via a trusted WLAN. In one form, a computer-implemented method is provided that may include obtaining, by an interworking function of a wireless local area network (WLAN) that interfaces with a control plane function and a user plane function of a mobile core network, an indication that a wireless device seeks to establish a session with the mobile core network, wherein the indication comprises first parameters associated with the session; and upon identifying, by the interworking function, that the first parameters match a route selection rule of a plurality of route selection rules for the wireless device, facilitating establishment of the session with the mobile core network based on the first parameters. In one instance, the wireless device is not capable of Non-Access-Stratum (NAS) signaling with the mobile core network via the WLAN.

In one instance, the method may further include facilitating, by the interworking function, registration of the wireless device with the mobile core network. In one instance, the method may further include, upon registration and authentication of the wireless device with the mobile core network, obtaining, by the interworking function, a route selection policy envelope for the wireless device, wherein the route selection policy envelope comprises the plurality of route selection rules for the wireless device.

In one instance, the method may further include sending the route selection policy envelope to the wireless device via a WLAN communication. The WLAN communication may be a WLAN action frame or a WLAN Fast-Initial Link Setup (FILS) association response message.

In one instance, the indication is obtained by the interworking function based on a WLAN action frame transmitted by the wireless device in which the WLAN action frame includes the first parameters. In one instance, the WLAN action frame further includes an identifier for the wireless device to be used for Dynamic Host Configuration Protocol signaling for the wireless device.

In one instance, the indication is obtained by the interworking function based on a WLAN Fast-Initial Link Setup (FILS) association request transmitted by the wireless device in which the WLAN FILS association request includes the first parameters.

In one instance, the method includes providing an Internet Protocol (IP) address for the wireless device for the session established with the mobile core network.

In one instance, the first parameters include a network slice identifier and a data network name (DNN) identifier.

In one instance, the method may further include obtaining, by the interworking function, a device capability indication indicating that the wireless device is capable of providing protocol data unit (PDU) session establishment parameters to the WLAN. In one instance, the device capability indication is obtained based on at least one of a WLAN association request transmission or a WLAN probe request transmission by the wireless device.

In one instance, the method may further include providing, to the wireless device, a WLAN capability indication indicating that the WLAN is capable of establishing multiple protocol data unit (PDU) sessions with the mobile core network for the wireless device. In one instance, the WLAN capability indication is provided to the wireless device via at least one of a WLAN beacon transmission, a WLAN probe response transmission, or a WLAN association response transmission from an access point of the WLAN that interfaces with the interworking function.

In one instance, the method may further include obtaining, by the interworking function, another indication that the wireless device seeks to establish another session with the mobile core network, wherein the another indication comprises second parameters associated with the another session; and upon identifying, by the interworking function, that the third parameters match another route selection rule of the plurality of route selection rules for the wireless device, facilitating, by the interworking function, establishment of the another session with the mobile core network based on the second parameters.

In one form, another computer-implemented method may be performed that may include providing, to a wireless device via a communication of a wireless local area network (WLAN), a plurality of route selection rules for the wireless device; obtaining, by an interworking function of the WLAN that interfaces with a control plane function and a user plane function of a mobile core network, an indication that the wireless device seeks to establish a session with the mobile core network, wherein the indication includes parameters identified in a particular route selection rule of the plurality of route selection rules; and facilitating, by the interworking function, establishment of the session with the mobile core network based on the parameters. The wireless device is not capable of Non-Access-Stratum (NAS) signaling with the mobile core network via the WLAN. In one instance, the method may further include facilitating, by the interworking function, registration of the wireless device with the mobile core network; and upon registration and authentication of the wireless device with the mobile core network, obtaining, by the interworking function, a route selection policy envelope for the wireless device, wherein the route selection policy envelope comprises the plurality of route selection rules for the wireless device.

In one form, an interworking function of a wireless local area network (WLAN) is provided, comprising: a plurality of network interfaces to interface, at least in part, with a control plane function and a user plane function of a mobile core network; at least one memory element for storing data; and at least one processor for executing instructions associated with the data, wherein executing the instructions causes the interworking function to perform operations, comprising: obtaining an indication that a wireless device seeks to establish a session with the mobile core network, wherein the indication comprises first parameters associated with the session and is obtained via a WLAN communication of the wireless device; and upon identifying that the first parameters match a route selection rule of a plurality of route selection rules for the wireless device, facilitating establishment of the session with the mobile core network based on the first parameters.

### Variations and Implementations

In general, for a mobile core network, an AMF interfaces with a SMF which can further interface with one or more UPFs. An AMF and an SMF can further interface with PCF, a UDM/UDR, and various other core network functions via 3GPP Service-Based Interface (SBI) constructs/interfaces and/or any other 3GPP interfaces/reference points. An AMF and a UPF can further interface with a RAN node, such as one or more gNBs or disaggregated components thereof.

A wireless device, such as any N5CW device and/or any other wireless devices discussed herein, may be considered any electronic device, etc. that initiates a connection or communication session with a corresponding core network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more RAN(s).

Generally, an AMF may facilitate access and mobility management control/services for one or more wireless devices seeking connection to/connected to a mobile core network. Generally, an SMF may be responsible for wireless device session management, with individual functions/services being supported on a per-session basis in order to facilitate data transfer(s) between a wireless device and one or more networks via one or more UPFs. Generally, a UPF may operate to provide packet routing and forwarding operations for user data traffic and may also perform a variety of functions such as packet inspection, traffic optimization, Quality of Service (QoS), policy enforcement and user data traffic handling (e.g., to/from one or more data networks), billing operations (e.g., accounting, etc.), among other operations, for wireless device sessions. Typically, a UDM stores subscription data (typically in combination with a UDR) for subscribers (e.g., a user that may be associated with a given wireless device) that can be retrieved and/or otherwise obtained/utilized during operation of a core network system. Typically, a PCF stores policy data in order to provide policy control services (e.g., to facilitate access control for one or more devices, network selection, etc.). Typically, a charging function (CHF) provides support for charging services such as facilitating the transfer of policy counter information associated with subscriber spending limits, etc.

In general, authentication services may include authenticating and/or authorizing one or more device(s) for one or more connections and/or communications and may be inclusive of any Authentication, Authorization, and Accounting (AAA) services that may be facilitated via any combination of authentication/authorization protocols such as Remote Authentication Dial-In User Service (RADIUS), DIAMETER, Extensible Authentication Protocol (EAP) [including any EAP variations], and/or the like. Generally, authentication refers to a process in which an entity's identity is authenticated, typically by providing evidence that it holds a specific digital identity such as an identifier/identity and corresponding credentials/authentication attributes/etc. Generally, authorization can be used to determine whether a particular entity is authorized to perform a given activity.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by an interworking function of a wireless local area network (WLAN) that interfaces with a control plane function and a user plane function of a mobile core network, an indication that a wireless device seeks to establish a session with the mobile core network, wherein the indication comprises first parameters associated with the session and is obtained via a WLAN communication of the wireless device; and
upon identifying, by the interworking function, that the first parameters match a route selection rule of a plurality of route selection rules for the wireless device, facilitating establishment of the session with the mobile core network based on the first parameters.

2. The method of claim 1, wherein the wireless device is not capable of Non-Access-Stratum (NAS) signaling with the mobile core network via the WLAN.

3. The method of claim 1, further comprising:
facilitating, by the interworking function, registration of the wireless device with the mobile core network.

4. The method of claim 3, further comprising:
upon registration and authentication of the wireless device with the mobile core network, obtaining, by the interworking function, a route selection policy envelope for the wireless device, wherein the route selection policy envelope comprises the plurality of route selection rules for the wireless device.

5. The method of claim 4, further comprising:
sending the route selection policy envelope to the wireless device via a WLAN communication.

6. The method of claim 5, wherein the WLAN communication is a WLAN action frame or a WLAN Fast-Initial Link Setup (FILS) association response message.

7. The method of claim 1, wherein the indication is obtained by the interworking function based on a WLAN action frame transmitted by the wireless device in which the WLAN action frame includes the first parameters.

8. The method of claim 7, wherein the WLAN action frame further includes an identifier for the wireless device to be used for Dynamic Host Configuration Protocol signaling for the wireless device.

9. The method of claim 1, wherein the indication is obtained by the interworking function based on a WLAN Fast-Initial Link Setup (FILS) association request transmitted by the wireless device in which the WLAN FILS association request includes the first parameters.

10. The method of claim 1, further comprising:
providing an Internet Protocol (IP) address for the wireless device for the session established with the mobile core network.

11. The method of claim 1, wherein the first parameters include a network slice identifier and a data network name (DNN) identifier.

12. The method of claim 1, further comprising:
obtaining, by the interworking function, a device capability indication indicating that the wireless device is capable of providing protocol data unit (PDU) session establishment parameters to the WLAN.

13. The method of claim 12, wherein the device capability indication is obtained based on at least one of a WLAN association request transmission or a WLAN probe request transmission by the wireless device.

14. The method of claim 1, further comprising:
providing, to the wireless device, a WLAN capability indication indicating that the WLAN is capable of establishing multiple protocol data unit (PDU) sessions with the mobile core network for the wireless device.

15. The method of claim 14, wherein the WLAN capability indication is provided to the wireless device via at least one of a WLAN beacon transmission, a WLAN probe response transmission, or a WLAN association response transmission from an access point of the WLAN that interfaces with the interworking function.

16. The method of claim 1, further comprising:
obtaining, by the interworking function, another indication that the wireless device seeks to establish another session with the mobile core network, wherein the another indication comprises second parameters associated with the another session; and
upon identifying, by the interworking function that the second parameters match another route selection rule of the plurality of route selection rules for the wireless device, facilitating establishment of the another session with the mobile core network based on the second parameters.

17. A method, comprising:
providing, to a wireless device via a communication of a wireless local area network (WLAN), a plurality of route selection rules for the wireless device;
obtaining, by an interworking function of the WLAN that interfaces with a control plane function and a user plane function of a mobile core network, an indication that the wireless device seeks to establish a session with the mobile core network, wherein the indication includes parameters identified in a particular route selection rule of the plurality of route selection rules; and
facilitating, by the interworking function, establishment of the session with the mobile core network based on the parameters.

18. The method of claim 17, wherein the wireless device is not capable of Non-Access-Stratum (NAS) signaling with the mobile core network via the WLAN.

19. The method of claim 17, further comprising:
facilitating, by the interworking function, registration of the wireless device with the mobile core network; and
upon registration and authentication of the wireless device with the mobile core network, obtaining, by the interworking function, a route selection policy envelope for the wireless device, wherein the route selection policy envelope comprises the plurality of route selection rules for the wireless device.

20. An interworking function of a wireless local area network (WLAN), comprising:
a plurality of network interfaces to interface, at least in part, with a control plane function and a user plane function of a mobile core network;
at least one memory element for storing data; and
at least one processor for executing instructions associated with the data, wherein executing the instructions causes the interworking function to perform operations, comprising:
obtaining an indication that a wireless device seeks to establish a session with the mobile core network, wherein the indication comprises first parameters associated with the session and is obtained via a WLAN communication of the wireless device; and
upon identifying that the first parameters match a route selection rule of a plurality of route selection rules for the wireless device, facilitating establishment of the session with the mobile core network based on the first parameters.
